(19) United States
(12) Patent Application Publication
(10) Pub. No.: US 2026/0177452 A1
(43) Pub. Date: Jun. 25, 2026

(54) EXPOSURE APPARATUS, EXPOSURE METHOD, AND METHOD FOR MANUFACTURING HOLOGRAPHIC OPTICAL ELEMENT

(71) Applicant: Panasonic Intellectual Property Management Co., Ltd., Osaka (JP)

(72) Inventors: Taito MIWA, Osaka (JP); Wahei AGEMIZU, Osaka (JP)

(21) Appl. No.: 19/418,094

(22) Filed: Dec. 12, 2025

(30) Foreign Application Priority Data
Dec. 20, 2024 (JP) 2024-225554
Dec. 20, 2024 (JP) 2024-225571
Mar. 18, 2025 (JP) 2025-043881
Mar. 18, 2025 (JP) 2025-043891
Oct. 17, 2025 (JP) 2025-175680
Oct. 17, 2025 (JP) 2025-175684

(51) Int. Cl. G01M 11/02; G03H 1/18

(52) U.S. Cl. CPC G01M 11/0242; G03H 1/18

(57) ABSTRACT

To accurately measure the diffraction efficiency of a holographic optical element during exposure.
An exposure apparatus used for exposing a volume hologram to light includes a laser light source that irradiates the volume hologram with first light which is light with a predetermined wavelength range in order to detect the diffraction efficiency of the volume hologram during exposure, a power meter that detects the amount of first light, and a power meter that detects the amount of second light which is the first light diffracted by the volume hologram.

### BACKGROUND

The present disclosure relates to an exposure apparatus, an exposure method, and a method for manufacturing a holographic optical element.

There has been conventionally known an exposure apparatus for manufacturing a holographic optical element. For example, an interference exposure apparatus of Japanese Unexamined Patent Publication No. 2006-209003 includes a first laser light source for exposure and a second laser light source for monitoring. In Japanese Unexamined Patent Publication No. 2006-209003, a recording material is irradiated with light from the second laser light source, and the intensity of light diffracted by the recording material is monitored. In this manner, a desired diffraction grating (holographic optical element) is produced.

### SUMMARY

However, in Japanese Unexamined Patent Publication No. 2006-209003, the diffraction efficiency of the holographic optical element is measured (monitored) using only the intensity of light diffracted by the recording material out of the light emitted from the second laser light source, and for this reason, when the amount of light emitted from the second laser light source changes, the diffraction efficiency of the holographic optical element cannot be accurately measured. As a result, the diffraction efficiency of the holographic optical element varies.

For example, when the output of the second laser light source changes by about ±1%, the diffraction efficiency of the holographic optical element varies by about ±1%. In this case, such a holographic optical element cannot be used for an application requiring a high standard of quality. For example, for a vehicle, a variation in the diffraction efficiency needs to be suppressed to about ±3%, and assuming that the diffraction efficiency of the holographic optical element varies by about ±1%, the quality thereof is greatly affected.

For this reason, an object of the present disclosure is to provide an exposure apparatus, an exposure method, and a method for manufacturing a holographic optical element, which are capable of accurately measuring the diffraction efficiency of the holographic optical element during exposure.

In order to achieve the above-described object, an exposure apparatus according to one embodiment of the present disclosure is an exposure apparatus used for exposing a holographic optical element to light, which includes a first light source that irradiates the holographic optical element with first light which is light with a predetermined wavelength range in order to detect the diffraction efficiency of the holographic optical element during exposure, a first detector that detects the amount of first light, and a second detector that detects the amount of second light which is the first light diffracted by the holographic optical element.

According to the present disclosure, the diffraction efficiency of the holographic optical element during exposure can be accurately measured.

### BRIEF DESCRIPTION OF THE DRAWINGS

FIG. 1 is a side view of an exposure apparatus according to a first embodiment.

FIG. 2 is a flowchart showing operation of the exposure apparatus according to the first embodiment.

FIG. 3 is a graph showing one example of a change in the diffraction efficiency of a volume hologram according to the first embodiment.

FIG. 4 is a side view of an exposure apparatus according to a second embodiment.

FIG. 5 is a flowchart showing operation of the exposure apparatus according to the second embodiment.

FIGS. 6A to 6C are graphs showing one example of a change in a prediction value of the diffraction efficiency of a volume hologram according to the second embodiment.

FIG. 7 is a graph showing one example of a change in the diffraction efficiency of the volume hologram according to the second embodiment.

FIG. 8 is a graph showing one example of a change in the amount of laser light emitted to the volume hologram according to the second embodiment.

FIG. 9 a side view of an exposure apparatus according to a third embodiment.

FIG. 10 is a flowchart showing operation of the exposure apparatus according to the third embodiment.

FIGS. 11A to 11C are graphs showing one example of a change in a prediction value of the diffraction efficiency of a volume hologram according to the third embodiment.

FIG. 12 is a graph showing one example of a change in the diffraction efficiency of the volume hologram according to the third embodiment.

FIG. 13 is a graph showing one example of a change in the amount of bleaching light emitted to the volume hologram according to the third embodiment.

FIG. 14 is a side view of an exposure apparatus according to a fourth embodiment.

FIG. 15 is a flowchart showing operation of the exposure apparatus according to the fourth embodiment.

FIG. 16 is a graph showing one example of a change in the diffraction efficiency of a volume hologram according to the fourth embodiment.

FIG. 17 is a graph showing one example of a change in the amount of laser light emitted to the volume hologram according to the fourth embodiment.

FIG. 18 is a graph showing one example of a change in the amount of bleaching light emitted to the volume hologram according to the fourth embodiment.

### DETAILED DESCRIPTION

Hereinafter, embodiments of the present disclosure will be described in detail based on the drawings. The following description of the preferred embodiments is merely an example in nature, and is not intended to limit the scope, application, or use of the present disclosure. Note that in the following description, the same elements are denoted by the same reference numerals and detailed description thereof will be omitted as necessary.

Note that a volume hologram (volume hologram 5) used in the present disclosure is different from a two-dimensional diffraction grating configured such that there are fine recesses and protrusions at regular intervals on a surface, and is configured to three-dimensionally record a refractive-index distribution in the form of a sinusoidal wave in a volume. The direction and period of this sinusoidal wave and the amplitude of a refractive index difference are controlled so that light distribution control can be made on the volume hologram. Note that in the present disclosure, for the sake of convenience in description, the refractive-index distribution recorded in the volume hologram is in the form of the sinusoidal wave, but is not limited to the sinusoidal wave and may be in other complicated shapes.

By an exposure apparatus described below, an exposure method and a method for manufacturing a holographic optical element are implemented.

### First Embodiment

### (Entire Configuration of Exposure Apparatus)

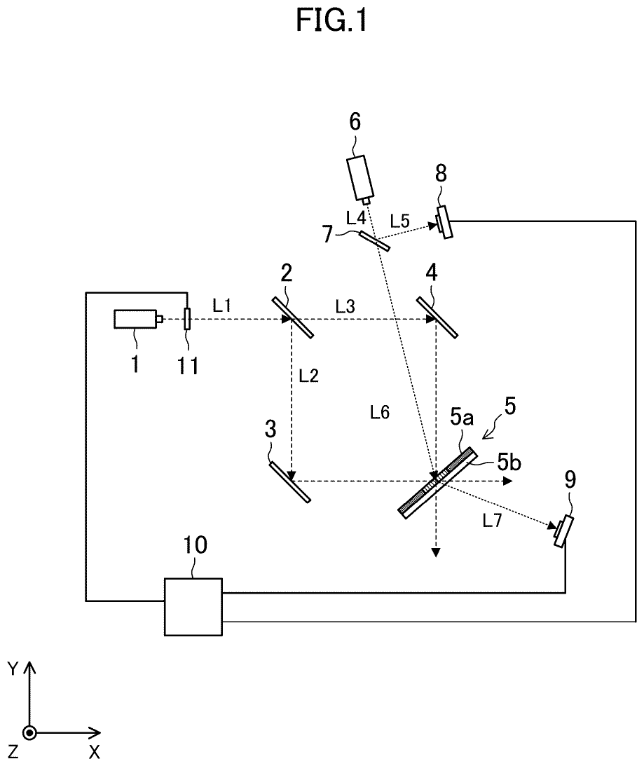

FIG. 1 is a side view of an exposure apparatus according to a first embodiment. Note that in FIG. 1, a direction of emitting laser light L3 is shown as an X-direction, a direction of emitting laser light L2 (object light) is shown as a Y-direction, and a direction (depth direction in the plane of paper) orthogonal to the X-direction and the Y-direction is shown as a Z-direction. Moreover, in FIG. 1, light emitted from laser light sources 1, 6 is indicated by a dashed arrow.

As shown in FIG. 1, the exposure apparatus according to the first embodiment includes the laser light source 1 (laser light source for exposure), a splitting mirror 2, mirrors 3, 4, a volume hologram 5 (holographic optical element), the laser light source 6 (laser light source for monitoring), a beam splitter 7 (optical element), a power meter 8 (first detector), a power meter 9 (second detector), a control device 10 (prediction device), and a shutter 11. Note that the volume hologram 5 is a volume hologram to be exposed to light (manufactured) by the present exposure apparatus.

The laser light source 1 is a light source that irradiates the splitting mirror 2 with laser light L1 (parallel light, third light). The laser light source 1 is a laser light source with a high coherence. Thus, even if the laser light L2 and the laser light L3 deviate from the same optical path length after the splitting mirror 2 (described later) splits the laser light L1 into the laser light L2 and the laser light L3, light interference therebetween can be made. The laser light L1 has the characteristics of linearly polarized light, and in the case of an insufficient polarization ratio, a wave plate, a polarizer, or the like may be inserted to control a polarization direction.

The shutter 11 for blocking the laser light L1 is provided between the laser light source 1 and the splitting mirror 2. The laser light source 1 and the shutter 11 operate in response to a signal from the control device 10. Note that the shutter 11 may be integrated with the laser light source 1.

Note that an optical system for converting the laser light L1 into parallel light may be provided between the laser light source 1 and the splitting mirror 2. For example, a condenser lens and a collimate lens may be provided between the laser light source 1 and the splitting mirror 2. In this case, the condenser lens condenses the laser light L1 from the laser light source 1 into diffusion light. The collimate lens converts the laser light L1 diffused by the condenser lens into parallel light.

The splitting mirror 2 splits the laser light L1 emitted from the laser light source 1 into two light fluxes. Specifically, the splitting mirror 2 splits the laser light L1 into the laser light L2 (object light) and the laser light L3 (reference light). For example, the splitting mirror 2 includes a polarization beam splitter and the like, and reflects linearly polarized light in a first polarization direction (laser light L2, for example S-polarized light) out of the laser light L1 and allows linearly polarized light in a second polarization direction (laser light L3, for example P-polarized light) to transmit therethrough.

The mirror 3 is a mirror that reflects the laser light L2 reflected by the splitting mirror 2. As shown in FIG. 1, the mirror 3 is formed in a planar shape. The laser light L2 is reflected by the mirror 3, and is emitted to the volume hologram 5. Note that the mirror 3 may have a curved surface.

The mirror 4 is a mirror that reflects the laser light L3 having transmitted through the splitting mirror 2. As shown in FIG. 1, the mirror 4 is formed in a planar shape. The laser light L3 is reflected by the mirror 4, and is emitted to the volume hologram 5. Note that the mirror 4 may have a curved surface.

The volume hologram 5 is a volume hologram to be exposed to light (manufactured) by the present exposure apparatus. The volume hologram 5 includes a photopolymer 5a and a base 5b. The photopolymer 5a is made of, for example, an optical material whose refractive index changes when receiving visible light. The base 5b is a flat plate with a high transmittance, and for example, quartz, optical glass, or the like is used for the base 5b.

In the present embodiment, when the volume hologram 5 is exposed to light, the volume hologram 5 is irradiated with the laser light L2 (object light) and the laser light L3 (reference light), and in this manner, an interference fringe (refractive-index distribution) is formed on the photopolymer 5a. That is, the volume hologram 5 is irradiated with the laser light L2, L3, and in this manner, is exposed to light. Thereafter, the volume hologram 5 is irradiated with ultraviolet light, and in this manner, is processed such that the formed interference fringe does not change. In this manner, the volume hologram 5 is manufactured.

Note that as shown in FIG. 1, the laser light L2, L3 may be parallel light, diverging light, or converging light when emitted to the volume hologram 5. For example, the mirror 3, 4 has the curved surface or an optical element such as a lens is disposed before or after the mirror 3, 4, so that light from the mirror 3, 4 can be converted into diverging light or converging light. In FIG. 1, the volume hologram 5 is irradiated with the laser light L2, L3 such that an angle between the directions of emitting such light is 90°, but the present disclosure is not limited thereto and the angle between these emitting directions may be any angle. In addition, the volume hologram 5 may be irradiated with the laser light L2 from the front surface side (or the back surface side), and may be irradiated with the laser light L3 from the back surface side (or the front surface side).

The laser light source 6 is a light source that irradiates the beam splitter 7 with laser light L4. The laser light L4 is light with such a wavelength range that the diffraction efficiency of the volume hologram 5 is not affected even when the volume hologram 5 which is being exposed to light is irradiated with the laser light L4 (for example, light with an infrared wavelength range of about 800 nm to 1500 nm). The laser light source 6 is a light source for detecting the diffraction efficiency of the volume hologram 5 which is being exposed to light. At this time, the laser light L4 enters at an angle satisfying a Bragg angle condition so as to be diffracted by the volume hologram 5. Note that the laser light L4 emitted from the laser light source 6 may be light with a wavelength range other than the above-described range.

The beam splitter 7 splits (divides) the laser light L4 emitted from the laser light source 6 into two light fluxes. Specifically, the beam splitter 7 splits the laser light L4 into laser light L5 and laser light L6. Note that instead of the beam splitter 7, a half mirror may be disposed. As long as the laser light L4 emitted from the laser light source 6 can be split into the two light fluxes, other optical elements may be used.

The power meter 8, 9 is a power meter that measures the amount of received light, for example. Note that the power meter 8, 9 may be any detector as long as the amount of laser light L5, L7 can be detected.

The power meter 8 receives the laser light L5 split by the beam splitter 7, and to the control device 10, outputs data indicating the amount of received laser light L5.

The laser light L6 (first light) split by the beam splitter 7 enters the volume hologram 5. Then, the laser light L6 is diffracted by the volume hologram 5, and thereafter, enters (is received by) the power meter 9 as the laser light L7 (second light). The power meter 9 outputs, to the control device 10, data indicating the amount of received laser light L7.

The control device 10 is, for example, a computer including a CPU, a ROM, a RAM, and the like. The control device 10 controls a process of exposing the volume hologram 5 to light based on the data output from the power meters 8, 9. Specifically, the control device 10 controls the laser light source 1 and the shutter 11 according to a prediction value (described in detail later) of the diffraction efficiency of the volume hologram 5.

### (Operation of Exposure Apparatus)

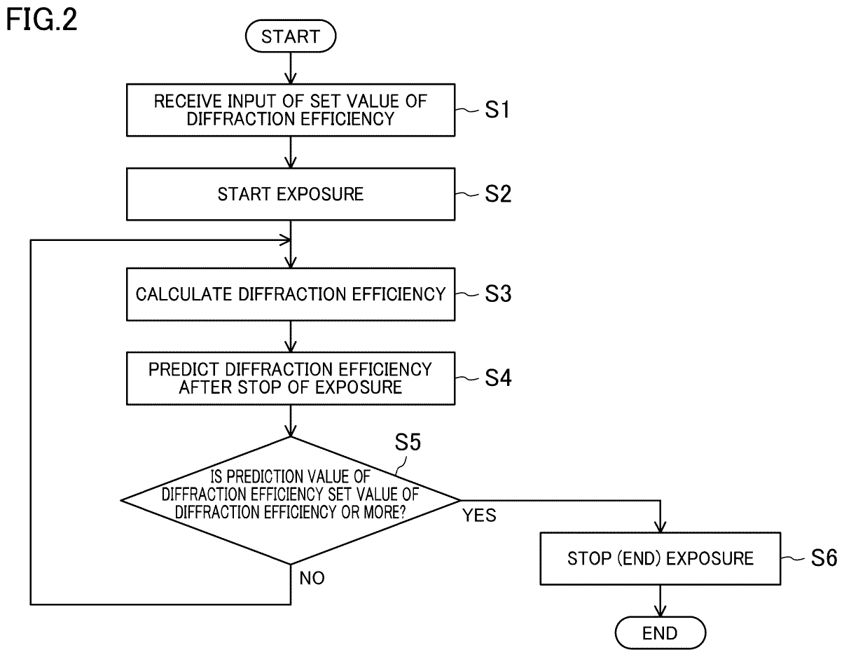

FIG. 2 is a flowchart showing operation of the exposure apparatus according to the present embodiment.

First, the control device 10 receives a user's input of a set value of the diffraction efficiency of the volume hologram 5 to be produced via an operator or the like (not shown) (Step S1). At this time, the set value of the diffraction efficiency of the volume hologram 5 received by the control device 10 is a set value of the diffraction efficiency of the volume hologram 5 in the wavelength range of green light (for example, about 500 nm to 550 nm). Then, the control device 10 converts the input set value of the diffraction efficiency of the volume hologram 5 into a set value of the diffraction efficiency of the volume hologram 5 in the infrared wavelength range (for example, light with an infrared wavelength range of about 800 nm to 1500 nm). The control device 10 uses the converted set value of the diffraction efficiency of the volume hologram 5 in the infrared wavelength range for the following processing.

The control device 10 controls each unit of the present exposure apparatus, and starts exposure of the volume hologram 5 (Step S2). Specifically, when starting exposure of the volume hologram 5, the control device 10 controls the laser light source 1 and the shutter 11 such that the laser light source 1 emits the laser light L1 and the shutter 11 is in an open state.

The control device 10 calculates the diffraction efficiency of the volume hologram 5 based on the data output from the power meters 8, 9 (Step S3). Specifically, the control device 10 calculates the diffraction efficiency (first diffraction efficiency) of the volume hologram 5 which is being exposed to light based on the data output from the power meters 8, 9. The diffraction efficiency of the volume hologram 5 is obtained as a numerical value obtained by dividing the amount of laser light L7 (amount of second light) by the amount of laser light L6 (amount of first light). That is, in a case where the laser light source 6 which is the laser light source for monitoring emits the laser light L4, the diffraction efficiency of the volume hologram 5 is obtained as a numerical value obtained by dividing the amount of laser light L7 which is diffraction light diffracted by the volume hologram 5 by the amount of laser light L6 which is light entering the volume hologram 5. In the present embodiment, the amount of laser light L7 is included in the data output from the power meter 9. The amount of laser light L6 correlates with the amount of laser light L5, and therefore, can be measured based on the data (amount of laser light L5) output from the power meter 8.

In Patent Document 1, the diffraction efficiency of a holographic optical element is measured (monitored) using only the intensity of light diffracted by a recording material out of light emitted from a second laser light source, and for this reason, when the amount of light emitted from the second laser light source changes, the diffraction efficiency of the holographic optical element cannot be accurately measured. As a result, the diffraction efficiency of the holographic optical element varies.

For example, when the output of the second laser light source changes by about ±1%, the diffraction efficiency of the holographic optical element varies by about ±1%. In this case, such a holographic optical element cannot be used for an application requiring a high standard of quality. For example, for a vehicle, a variation in the diffraction efficiency needs to be suppressed to about ±3%, and assuming that the diffraction efficiency of the holographic optical element varies by about ±1%, the quality thereof is greatly affected. For this reason, the diffraction efficiency of the holographic optical element during exposure needs to be accurately measured.

For this reason, in the present embodiment, the diffraction efficiency of the volume hologram 5 is calculated based on an actual measurement value of the amount of laser light L7 which is the diffraction light diffracted by the volume hologram 5 and an actual measurement value of the amount of laser light L6 which is the light entering the volume hologram 5. This makes it possible to accurately measure the diffraction efficiency of the holographic optical element during exposure.

The control device 10 obtains the prediction value (second diffraction efficiency) of the diffraction efficiency of the volume hologram 5 (Step S4). Specifically, the control device 10 obtains an actual measurement value of the diffraction efficiency calculated in Step S3 and the amount of change therein based on such a diffraction efficiency. Then, the control device 10 takes, as the prediction value for the volume hologram 5, a value obtained by the actual measurement value of the diffraction efficiency+the amount of change×a coefficient. Note that the coefficient at this time is set using various results, machine learning (AI), or the like. The control device 10 determines whether or not the prediction value of the diffraction efficiency of the volume hologram 5 is the set value of the diffraction efficiency of the volume hologram 5 or more (Step S5). In a case where the prediction value of the diffraction efficiency of the volume hologram 5 falls below the set value of the diffraction efficiency of the volume hologram 5 (No in Step S5), the control device 10 returns the processing to Step S3. In

a case where the prediction value of the diffraction efficiency of the volume hologram 5 is the set value of the diffraction efficiency of the volume hologram 5 or more (Yes in Step S5), the control device 10 stops (ends) exposure of the volume hologram 5 (Step S6). Specifically, when stopping exposure of the volume hologram 5, the control device 10 controls the laser light source 1 and the shutter 11 such that emission of the laser light L1 (third light) from the laser light source 1 stops and the shutter 11 is in a closed state. That is, the control device 10 controls the process of exposing the volume hologram 5 to light (here, stops (ends) exposure) according to the calculated diffraction efficiency.

Thereafter, the volume hologram 5 is irradiated with ultraviolet light, and in this manner, is processed such that the formed interference fringe does not change.

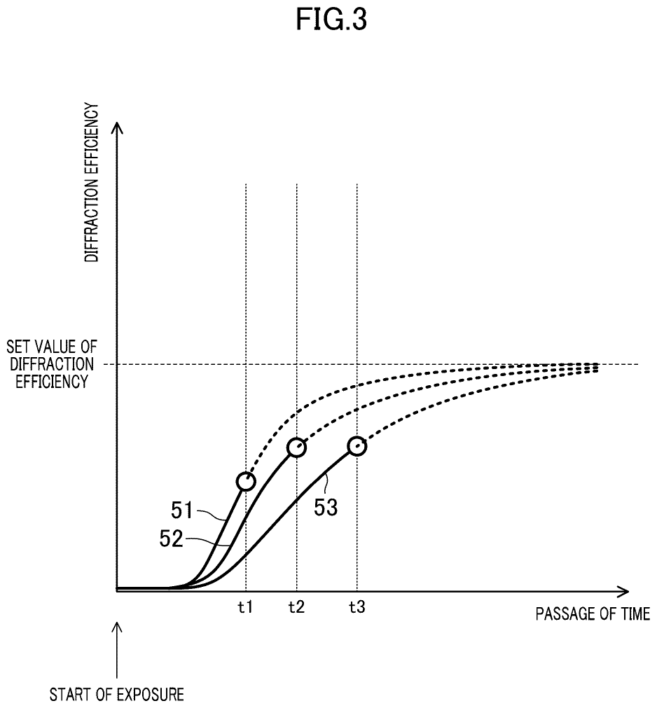

FIG. 3 is a graph showing one example of a change in the diffraction efficiency of the volume hologram according to the first embodiment. FIG. 3 shows the diffraction efficiencies of volume holograms 51 to 53 different from each other in material and thickness. In FIG. 3, exposure of the volume holograms 51 to 53 is stopped at time points t1 to t3.

Even after emission of exposure light is stopped in order to stop (end) exposure, the diffraction efficiency of the holographic optical element continuously changes for a predetermined period. This may be because a change (chemical reaction) in the material of the holographic optical element continues even after the stop of exposure. A change in the diffraction efficiency of the holographic optical element varies according to the material and thickness of the holographic optical element. As a result, the diffraction efficiency of the produced holographic optical element varies.

Specifically, as shown in FIG. 3, when exposure starts, the diffraction efficiencies of the volume holograms 51 to 53 start increasing. Then, even after the stop (end) of exposure, an increase in the diffraction efficiencies of the volume holograms 51 to 53 continues. This may be because a change (chemical reaction) in the material of the volume hologram continues even after the stop of exposure. That is, it can be said that the diffraction efficiency of the volume hologram is not immediately stopped (stabilized) even after the stop of exposure. Particularly, a change in the diffraction efficiency of the volume hologram varies according to the material and thickness thereof.

For this reason, in the present embodiment, the control device 10 calculates the diffraction efficiency of the volume hologram 5 based on the measurement results (actual measurement values of the amounts of laser light L6 and laser light L7) of the power meters 8, 9, predicts the diffraction efficiency of the volume hologram 5 after the stop of exposure according to the calculation result of the diffraction efficiency, and stops exposure of the volume hologram 5 according to the prediction result. That is, the control device 10 controls the process of exposing the holographic optical element to light according to the calculation result of the diffraction efficiency of the volume hologram 5. This makes it possible to produce the volume hologram with the set diffraction efficiency even for different materials and thicknesses.

### Second Embodiment

### (Entire Configuration of Exposure Apparatus)

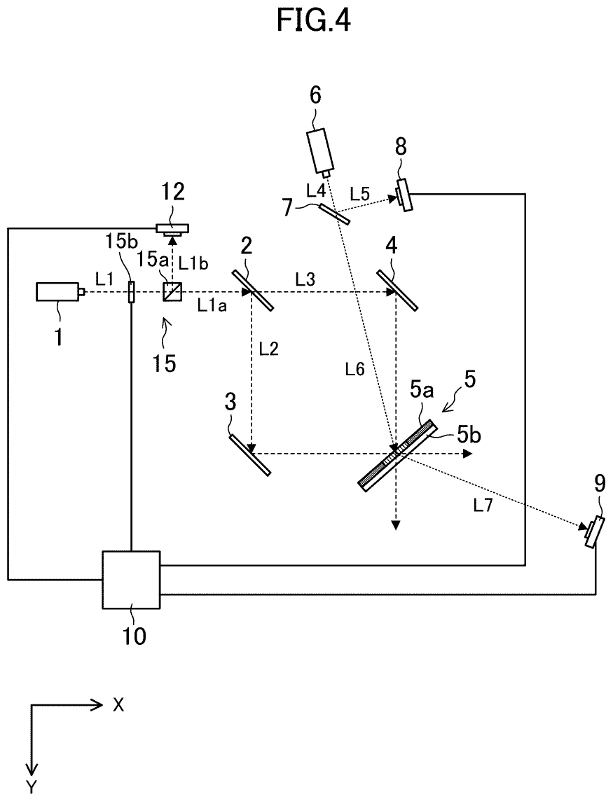

FIG. 4 is a side view of an exposure apparatus according to a second embodiment. As compared to FIG. 1, an attenuator 15 is provided instead of the shutter 11 between the laser light source 1 and the splitting mirror 2 in FIG. 4. Specifically, the attenuator 15 is an adjustment device that controls the amount of laser light L1 output from the laser light source 1. The attenuator 15 includes a λ/2 wave plate 15a and a polarization beam splitter 15b.

The λ/2 wave plate 15a is a wave plate that changes the direction of polarization of incident light. The polarization beam splitter 15b splits incident light into S-polarized light and P-polarized light. When entering the λ/2 wave plate 15a, the laser light L1 changes its polarization direction. Thereafter, the laser light L1 is split into S-polarized light (laser light L1a) and P-polarized light (laser light L1b) by the polarization beam splitter 15b. Thereafter, the laser light L1a enters the splitting mirror 2, and the laser light L1b enters a power meter 12. The power meter 12 is a power meter that measures the amount of received light, and measures the amount of laser light L1b.

Here, the λ/2 wave plate 15a is rotatable with the X-direction as a center axis. The direction of polarization of the laser light L1 can be changed by rotating the λ/2 wave plate 15a, and therefore, the amounts of laser light L1a and laser light L1b can be changed. At this time, the amount of laser light L1a can be obtained according to the amount of laser light L1b. Note that the control device 10 can measure the amount of laser light L1 (L1a) according to a measurement result of the power meter 12.

Note that an ND filter may be provided instead of the attenuator 15. In this case, the amount of laser light L1 can also be controlled.

The attenuator 15 may be omitted, and the laser light source 1 may be provided with a light amount control device that controls the amount of laser light L1 (output). The control device 10 may control the light amount control device to change the amount of laser light L1. The control device 10 controls the process of exposing the volume hologram 5 to light based on the data output from the power meters 8, 9. Specifically, the control device 10 controls the attenuator 15 (λ/2 wave plate 15a) according to the prediction value of the diffraction efficiency of the volume hologram 5.

### (Operation of Exposure Apparatus)

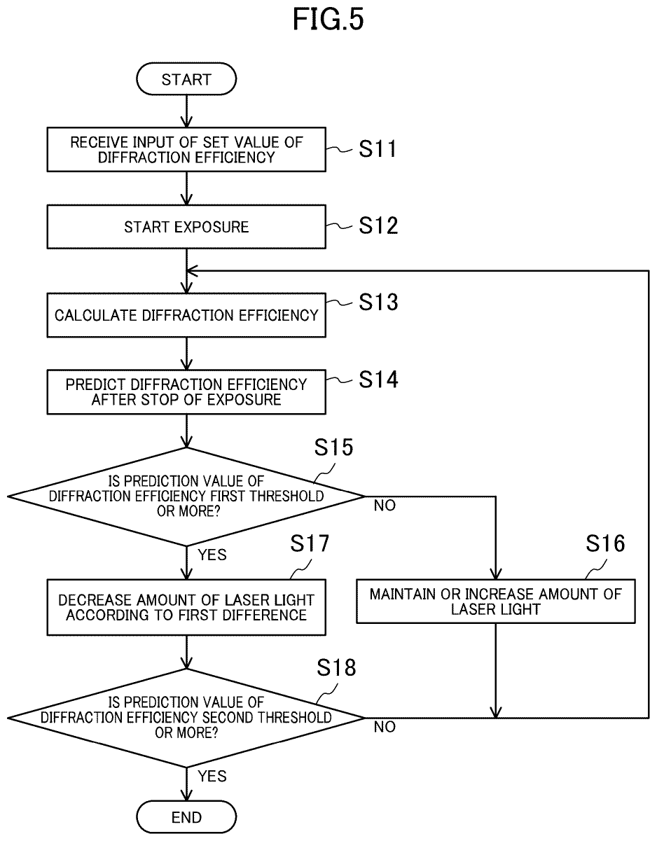

FIG. 5 is a flowchart showing operation of the exposure apparatus according to the second embodiment.

First, the control device 10 receives the user's input of the set value of the diffraction efficiency of the volume hologram 5 to be produced via the operator or the like (not shown) (Step S11). At this time, the set value of the diffraction efficiency of the volume hologram 5 received by the control device 10 is the set value of the diffraction efficiency of the volume hologram 5 in the wavelength range of green light (for example, about 500 nm to 550 nm). Then, the control device 10 converts the input set value of the diffraction efficiency of the volume hologram 5 into the set value of the diffraction efficiency of the volume hologram 5 in the infrared wavelength range (for example, light with an infrared wavelength range of about 800 nm to 1500 nm). The control device 10 uses the converted set value of the diffraction efficiency of the volume hologram 5 in the infrared wavelength range for the following processing.

Moreover, in Step S11, the control device 10 sets a first threshold and a second threshold (described later) according to the input of the set value of the diffraction efficiency. The control device 10 controls each unit of the present exposure apparatus, and starts exposure of the volume hologram 5 (Step S12). Specifically, the control device 10 controls the attenuator 15 (specifically, rotates the λ/2 wave plate 15a) such that the amount of laser light L1 (L1a) emitted from the laser light source 1 reaches a predetermined value. The control device 10 calculates the diffraction efficiency (first diffraction efficiency) of the volume hologram 5 based on the data output from the power meters 8, 9 (Step S13). Specifically, the control device 10 calculates the diffraction efficiency of the volume hologram 5 which is being exposed to light based on the data output from the power meters 8, 9. The diffraction efficiency of the volume hologram 5 is obtained as the numerical value obtained by dividing the amount of laser light L7 (amount of second light) by the amount of laser light L6 (amount of first light). That is, in a case where the laser light source 6 which is the laser light source for monitoring emits the laser light L4, the diffraction efficiency of the volume hologram 5 is obtained as the numerical value obtained by dividing the amount of laser light L7 which is the diffraction light diffracted by the volume hologram 5 by the amount of laser light L6 which is the light entering the volume hologram 5. In the present embodiment, the amount of laser light L7 is included in the data output from the power meter 9. The amount of laser light L6 correlates with the amount of laser light L5, and therefore, the amount of laser light L6 can be measured based on the data (amount of laser light L5) output from the power meter 8. That is, in the present embodiment, the diffraction efficiency of the volume hologram 5 is calculated based on the actual measurement value of the amount of laser light L7 which is the diffraction light diffracted by the volume hologram 5 and the actual measurement value of the amount of laser light L6 which is the light entering the volume hologram 5, and therefore, the diffraction efficiency of the holographic optical element during exposure can be accurately measured.

The control device 10 obtains the prediction value (second diffraction efficiency) of the diffraction efficiency of the volume hologram 5 (Step S14). Specifically, the control device 10 obtains the actual measurement value of the diffraction efficiency calculated in Step S13 and the amount of change therein based on such a diffraction efficiency. Then, the control device 10 takes, as the prediction value of the volume hologram 5, the value obtained by the actual measurement value of the diffraction efficiency+the amount of change×the coefficient. Note that the coefficient at this time is set using various results, machine learning (AI), or the like. The control device 10 controls the attenuator 15 such that the prediction value of the diffraction efficiency of the volume hologram 5 does not exceed the set value of the diffraction efficiency of the volume hologram 5.

Specifically, the control device 10 determines whether or not the prediction value of the diffraction efficiency of the volume hologram 5 is the first threshold or more (Step S15). In a case where the prediction value of the diffraction efficiency of the volume hologram 5 is less than the first threshold (No in Step S15), the control device 10 controls the attenuator 15 such that the amount of laser light L1 increases or is maintained according to a first difference (Step S16). Specifically, the control device 10 rotates the λ/2 wave plate 15a such that the amount of laser light L1 increases or is maintained. After Step S16, the processing returns to Step S13.

In a case where the prediction value of the diffraction efficiency of the volume hologram 5 is the first threshold or more (Yes in Step S15), the control device 10 controls the attenuator 15 such that the amount of laser light L1 decreases according to the first difference (Step S17). Specifically, the control device 10 calculates the first difference. The first difference is the ratio (percentage (%)) of a second reference value to a first reference value. The first reference value is a value obtained by subtracting the first threshold from the set value

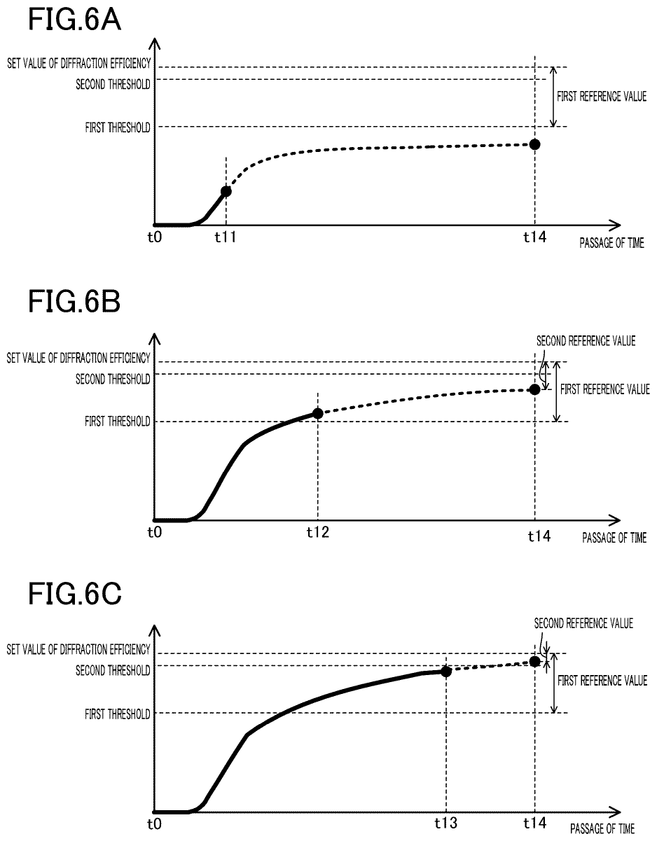

of the diffraction efficiency, and the second reference value is a value obtained by subtracting the prediction value of the diffraction efficiency from the set value of the diffraction efficiency (see FIG. 6). The control device 10 rotates the λ/2 wave plate 15a such that the calculated amount of laser light L1 decreases.

The control device 10 determines whether or not the prediction value of the diffraction efficiency of the volume hologram 5 is the second threshold or more (Step S18). In a case it is determined that the prediction value of the diffraction efficiency of the volume hologram 5 is less than the second threshold (No in Step S18), the control device 10 returns the processing to Step S3. In a case where it is determined that the prediction value of the diffraction efficiency of the volume hologram 5 is the second threshold or more (Yes in Step S18), the control device 10 ends the processing. Specifically, the control device 10 controls the laser light source 1 to stop emission of the laser light L1 (that is, end exposure of the volume hologram 5). For example, the second threshold is set such that the first difference is about 0.1%.

That is, the first threshold is a threshold as a reference for determining whether the amount of laser light L1 emitted to the volume hologram 5 is maintained or increased or decreased. Moreover, the second threshold is a threshold as a reference for stopping the laser light L1 emitted to the volume hologram 5, that is, stopping exposure of the volume hologram 5.

Thereafter, bleaching is performed on the volume hologram 5, and in this manner, the volume hologram 5 is processed such that the formed diffraction grating (interference fringe) does not change (fixed).

FIGS. 6A to 6C are graphs showing one example of a change in the prediction value of the diffraction efficiency of the volume hologram according to the second embodiment. In FIGS. 6A to 6C, time points t11 to t13 are the points of time (current point of time) when the diffraction efficiency of the volume hologram 5 is calculated in Step S13. In FIGS. 6A to 6C, a time point t14 is the point of time (for example, the point of time at which the diffraction efficiency of the volume hologram 5 is stabilized) as a reference taken when the prediction value of the diffraction efficiency of the volume hologram 5 is calculated in Step S14. That is, in the second embodiment, the diffraction efficiency of the volume hologram 5 at the time point t14 is predicted (Step S14) with reference to the diffraction efficiencies of the volume hologram 5 calculated at the time points t11 to t13 (Step S13). Note that in FIGS. 6A to 6C, a time point t0 is the point of time at which exposure of the volume hologram 5 starts.

Specifically, as shown in FIG. 6A, the prediction value of the diffraction efficiency of the volume hologram 5 at the time point t14 is less than the first threshold (No in Step S15), and therefore, the control device 10 maintains (or increases) the amount of laser light L1 (Step S16). Accordingly, the rate of change in the diffraction efficiency of the volume hologram 5 after the time point t11 increases. Thereafter, as shown in FIG. 6B, the prediction value of the diffraction efficiency of the volume hologram 5 at the time point t14 is the first threshold or more (Yes in Step S15) and less than the second threshold (No in Step S18), and therefore, the control device 10 decreases the amount of laser light L1 according to the first difference (Step S17). Accordingly, the rate of change in the diffraction efficiency of the volume hologram 5 after the time point t12 decreases. Then, as shown in FIG. 6C, the prediction value of the diffraction efficiency of the volume hologram 5 at the time point t14 is the second threshold or more (Yes in Step S18), and therefore, the control device 10 controls the laser light source 1 to stop emission of the laser light L1.

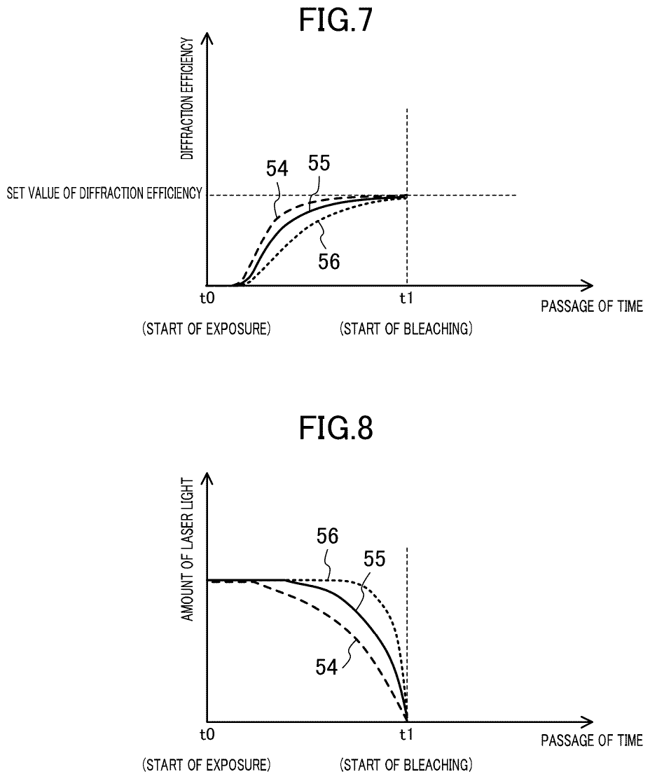

FIG. 7 is a graph showing one example of a change in the diffraction efficiency of the volume hologram according to the second embodiment. FIG. 8 is a graph showing one example of a change in the amount of laser light emitted to the volume hologram according to the second embodiment. FIG. 7 shows the diffraction efficiencies of volume holograms 54 to 56 different from each other in material and thickness. FIG. 8 shows the amounts of laser light L1 emitted to the volume holograms 54 to 56 (that is, the total of the amount of laser light L2 and the amount of laser light L3).

As shown in FIGS. 7 and 8, at the time point t0, exposure of the volume holograms 54 to 56 starts. After the start of exposure, the amount of laser light L1 increases to a predetermined value. After a lapse of some time from the time point t0, the diffraction efficiencies of the volume holograms 54 to 56 start increasing. Then, the amount of laser light L1 decreases until the time point t1. Thereafter, at the time point t1, bleaching starts on the volume holograms 54 to 56. In this manner, the volume hologram with the set diffraction efficiency is manufactured.

When the holographic optical element is manufactured, bleaching is performed on the holographic optical element in order to fix the diffraction grating formed by exposure after the stop (end) of exposure of the holographic optical element. In a period until the start of bleaching after the stop of exposure of the holographic optical element, the diffraction efficiency of the holographic optical element also changes. This may be because a change (chemical reaction) in the material of the holographic optical element continues even after the stop of exposure. A change in the diffraction efficiency of the holographic optical element varies according to the material and thickness of the holographic optical element. As a result, the diffraction efficiency of the produced holographic optical element varies.

For this reason, in the present embodiment, the control device 10 calculates the diffraction efficiency of the volume hologram 5 based on the measurement results (actual measurement values of the amounts of laser light L6 and laser light L7) of the power meters 8, 9, and controls the attenuator 15 (amount of laser light L1) according to the prediction of the diffraction efficiency of the volume hologram 5 after the stop of exposure. This makes it possible to produce the volume hologram with the set diffraction efficiency even for different materials and thicknesses.

The amount of laser light L1 which is exposure light for the volume hologram gradually decreases until the time of the start of bleaching. This makes it possible to shorten the period until the start of bleaching after the stop of exposure of the volume hologram, and therefore, a change in the diffraction efficiency of the volume hologram in such a period can be suppressed.

### Third Embodiment

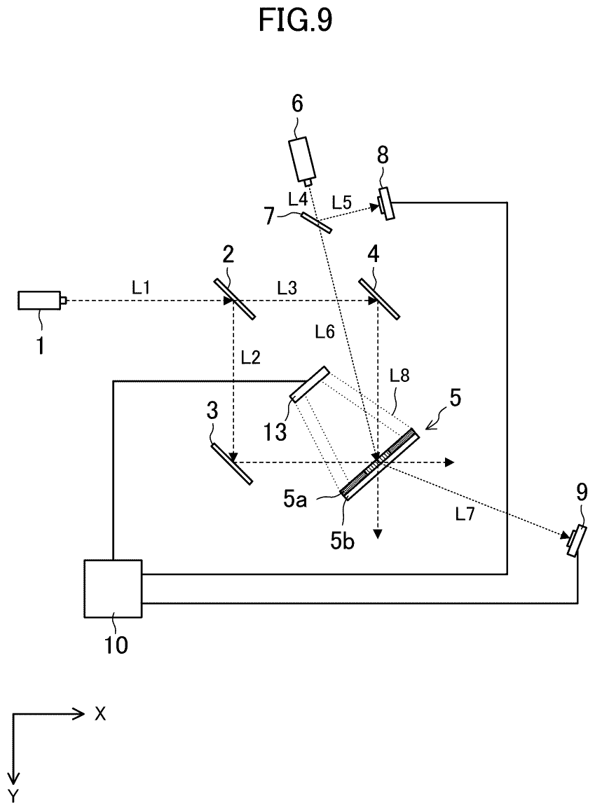

FIG. 9 is a side view of an exposure apparatus according to a third embodiment. As compared to FIG. 1, the shutter 11 is omitted and a bleaching light source 13 (third light source) is provided in FIG. 9.

The bleaching light source 13 irradiates the volume hologram 5 with bleaching light L8 for fixing the diffraction grating (interference fringe). For example, the bleaching light source 13 includes at least any one of a UV light source or a white light source, which includes an LED and the like.

In the third embodiment, the control device 10 controls the bleaching light source 13 according to the prediction value of the diffraction efficiency of the volume hologram 5.

### (Operation of Exposure Apparatus)

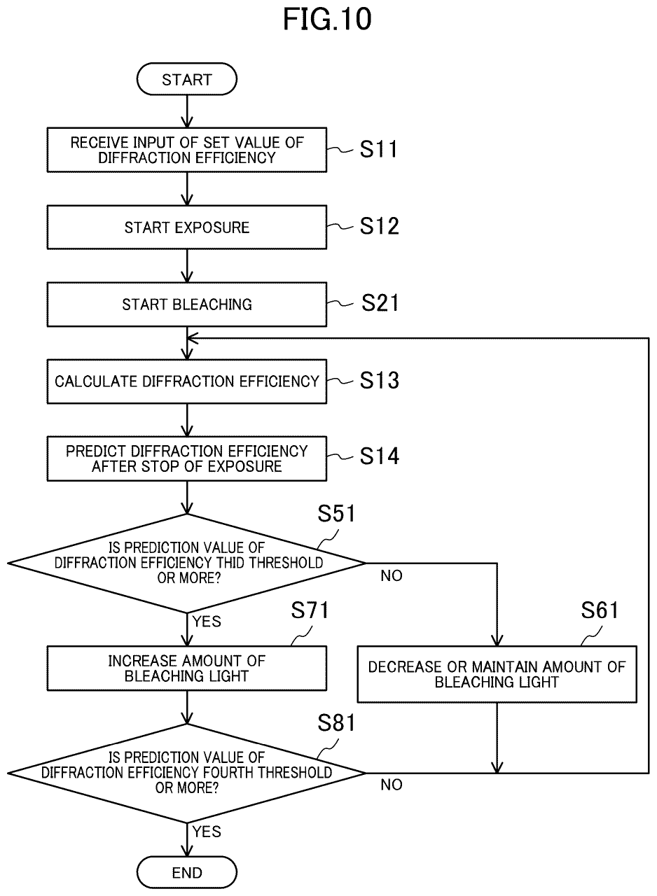

FIG. 10 is a flowchart showing operation of the exposure apparatus according to the third embodiment. As compared to FIG. 5, Step S21 is executed after Step S12 and Steps S51, S61, S71, S81 are executed instead of Steps S15 to S18 in FIG. 10. Note that in Step S11, the control device 10 sets a third threshold and a fourth threshold (described later) according to the input of the set value of the diffraction efficiency.

In Step S21, the control device 10 starts bleaching of the volume hologram 5. Specifically, the control device 10 controls the bleaching light source 13 to irradiate the volume hologram 5 with the bleaching light L8.

After Step S51, the control device 10 controls the bleaching light source 13 such that the prediction value (second diffraction efficiency) of the diffraction efficiency of the volume hologram 5 does not exceed the set value (first diffraction efficiency) of the diffraction efficiency of the volume hologram 5.

Specifically, the control device 10 determines whether or not the prediction value of the diffraction efficiency of the volume hologram 5 is the third threshold or more (Step S51). In a case where the prediction value of the diffraction efficiency of the volume hologram 5 is less than the third threshold (No in Step S51), the control device 10 controls the bleaching light source 13 such that the amount of bleaching light L8 decreases or is maintained (Step S61). After Step S61, the processing returns to Step S13.

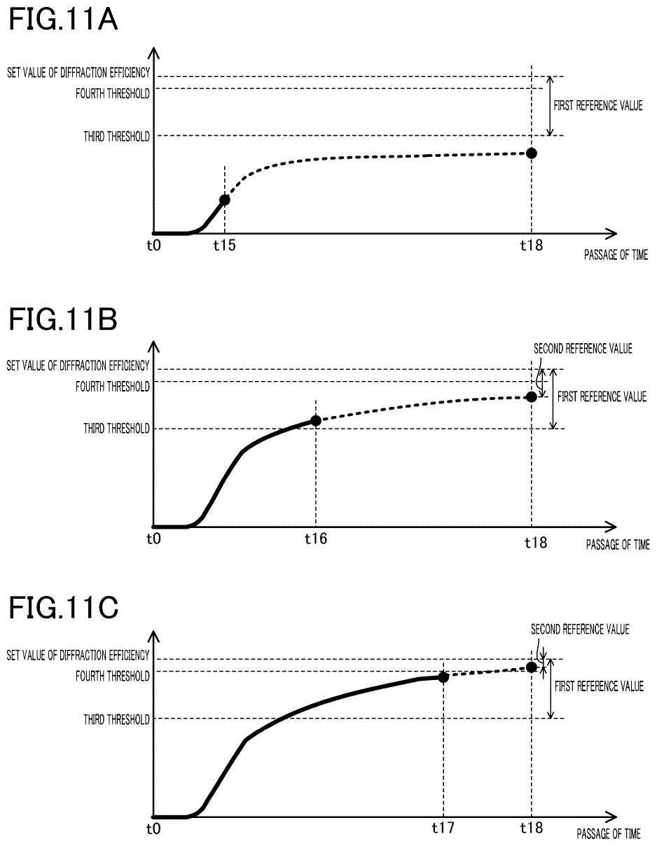

In a case where the prediction value of the diffraction efficiency of the volume hologram 5 is the third threshold or more (Yes in Step S61), the control device 10 controls the bleaching light source 13 such that the amount of bleaching light L8 increases (Step S71). Specifically, the control device 10 calculates the first difference. The first difference is the ratio (percentage (%)) of the second reference value to the first reference value. The first reference value is a value obtained by subtracting the third threshold from the set value of the diffraction efficiency, and the second reference value is a value obtained by subtracting the prediction value of the diffraction efficiency from the set value of the diffraction efficiency (see FIG. 11).

The control device 10 determines whether or not the prediction value of the diffraction efficiency of the volume hologram 5 is the fourth threshold or more (Step S81). In a case where it is determined that the prediction value of the diffraction efficiency of the volume hologram 5 is less than the fourth threshold (No in Step S81), the control device 10 returns the processing to Step S13. In a case where it is determined that the prediction value of the diffraction efficiency of the volume hologram 5 is the fourth threshold or more (Yes in Step S81), the control device 10 ends the processing. Thereafter, exposure and bleaching of the volume hologram 5 end. For example, the fourth threshold is set such that the first difference is about 0.1%.

That is, the third threshold is a threshold as a reference for determining whether the amount of bleaching light L8 emitted to the volume hologram 5 is maintained or decreased or increased. Moreover, the fourth threshold is a threshold as a reference for stopping the present processing (processing of increasing the amount of bleaching light L8 emitted to the volume hologram 5).

Note that in a case where the bleaching light source 13 includes the UV light source and the white light source, the control device 10 may control the amount of light of each of the UV light source and the white light source according to the prediction value of the diffraction efficiency of the volume hologram 5 in Steps S61, S71.

FIGS. 11A to 11C are graphs showing one example of a change in the prediction value of the diffraction efficiency of the volume hologram according to the third embodiment. In FIGS. 11A to 11C, time points t15 to t17 are the points of time (current point of time) when the diffraction efficiency of the volume hologram 5 is calculated in Step S13. In FIGS. 11A to 11C, a time point t18 is the point of time (for example, the point of time at which the diffraction efficiency of the volume hologram 5 is stabilized) as a reference taken when the prediction value of the diffraction efficiency of the volume hologram 5 is calculated in Step S14. That is, in the third embodiment, the diffraction efficiency of the volume hologram 5 at the time point t18 is predicted (Step S14) with reference to the diffraction efficiencies of the volume hologram 5 calculated at the time points t15 to t17 (Step S13). Note that in FIGS. 11A to 11C, the time point t0 is the point of time at which exposure of the volume hologram 5 starts.

Specifically, as shown in FIG. 11A, the prediction value of the diffraction efficiency of the volume hologram 5 at the time point t18 is less than the third threshold (No in Step S15), and therefore, the control device 10 maintains (or decreases) the amount of bleaching light L8 (Step S61). Accordingly, the rate of change in the diffraction efficiency of the volume hologram 5 after the time point t15 increases. Thereafter, as shown in FIG. 11B, the prediction value of the diffraction efficiency of the volume hologram 5 at the time point t18 is the third threshold or more (Yes in Step S51) and less than the fourth threshold (No in Step S81), and therefore, the control device 10 decreases the amount of laser light L1 according to the first difference (Step S71). Accordingly, the rate of change in the diffraction efficiency of the volume hologram 5 after the time point t16 decreases. Then, as shown in FIG. 11C, the prediction value of the diffraction efficiency of the volume hologram 5 at the time point t18 is the fourth threshold or more (Yes in Step S81), and therefore, the present processing ends.

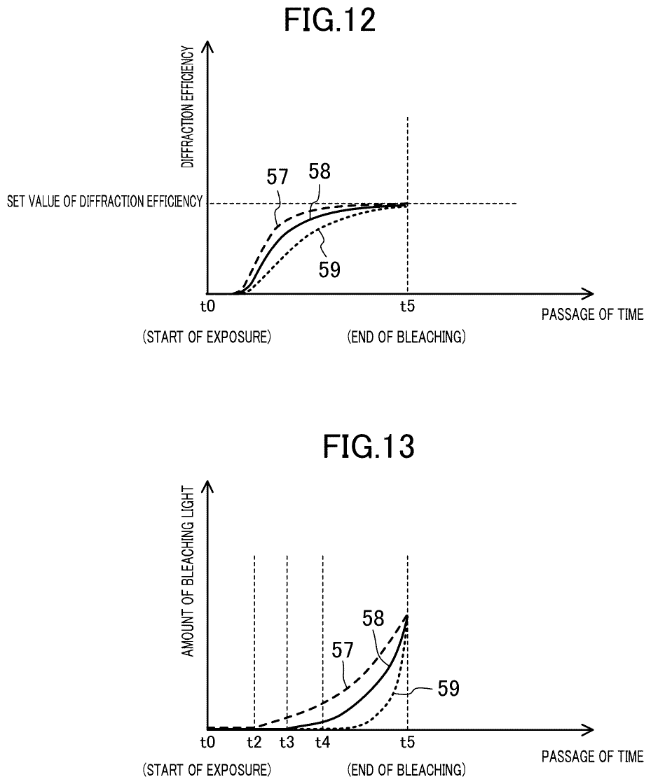

FIG. 12 is a graph showing one example of a change in the diffraction efficiency of the volume hologram according to the third embodiment. FIG. 13 is a graph showing one example of a change in the amount of bleaching light emitted to the volume hologram according to the third embodiment. FIG. 12 shows the diffraction efficiencies of volume holograms 57 to 59 different from each other in material and thickness. FIG. 13 shows the amounts of bleaching light L8 emitted to the volume holograms 57 to 59.

As shown in FIGS. 12 and 13, at the time point t0, exposure of the volume holograms 57 to 59 starts. After a lapse of some time from the time point t0, the diffraction efficiencies of the volume holograms 57 to 59 start increasing. Then, at the time points t2 to t4, bleaching of the volume holograms 57 to 59 starts. Then, at the time point t5, bleaching of the volume holograms 57 to 59 ends. In this manner, the volume hologram with the set diffraction efficiency is manufactured.

When the holographic optical element is manufactured, bleaching is performed on the holographic optical element in order to fix the diffraction grating formed by exposure after the stop (end) of exposure of the holographic optical element. During bleaching, the diffraction efficiency of the holographic optical element also changes. This may be because a change (chemical reaction) in the material of the holographic optical element continues even during bleaching. A change in the diffraction efficiency of the holographic optical element varies according to the material and thickness of the holographic optical element. As a result, the diffraction efficiency of the produced holographic optical element varies.

For this reason, in the present embodiment, the control device 10 calculates the diffraction efficiency of the volume hologram 5 based on the measurement results (actual measurement values of the amounts of laser light L6 and laser light L7) of the power meters 8, 9, and controls the bleaching light source 13 (amount of bleaching light L8) according to the prediction of the diffraction efficiency of the volume hologram 5 after the stop of exposure. This makes it possible to produce the volume hologram with the set diffraction efficiency even for different materials and thicknesses.

Bleaching is performed on the volume hologram during exposure of the volume hologram. This makes it possible to reduce the influence of a change in the diffraction efficiency of the volume hologram during bleaching.

### Fourth Embodiment

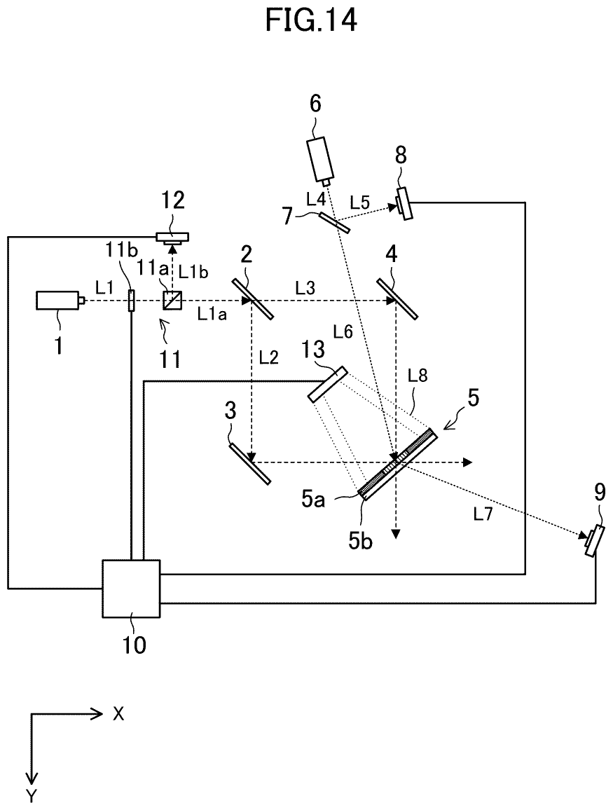

FIG. 14 is a side view of an exposure apparatus according to a fourth embodiment. As compared to FIG. 4, a bleaching light source 13 is further provided in FIG. 14. Note that the bleaching light source 13 has a configuration similar to that of the third embodiment.

In the fourth embodiment, the control device 10 controls the attenuator 15 and the bleaching light source 13 according to the prediction value of the diffraction efficiency of the volume hologram 5.

### (Operation of Exposure Apparatus)

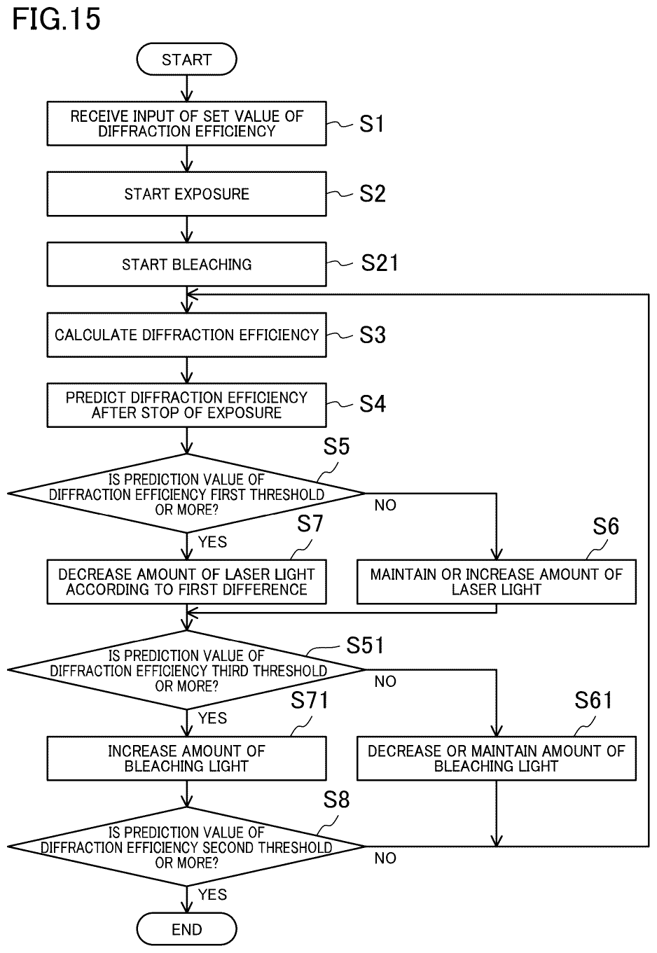

FIG. 15 is a flowchart showing operation of the exposure apparatus according to the fourth embodiment. As compared to FIG. 5, Step S21 is executed after Step S12 and Steps S51, S61, S71 are executed between Steps S17, 18 in FIG. 15. Note that Steps S21, S51, S61, S71 are the same as Steps S21, S51, S61, S71 of FIG. 10. That is, after Step S15, the control device 10 controls the attenuator 15 and the bleaching light source 13 such that the prediction value of the diffraction efficiency of the volume hologram 5 does not exceed the set value of the diffraction efficiency of the volume hologram 5. Note that in Step S11, the control device 10 sets the first threshold, the second threshold, and the third threshold according to the input of the set value of the diffraction efficiency.

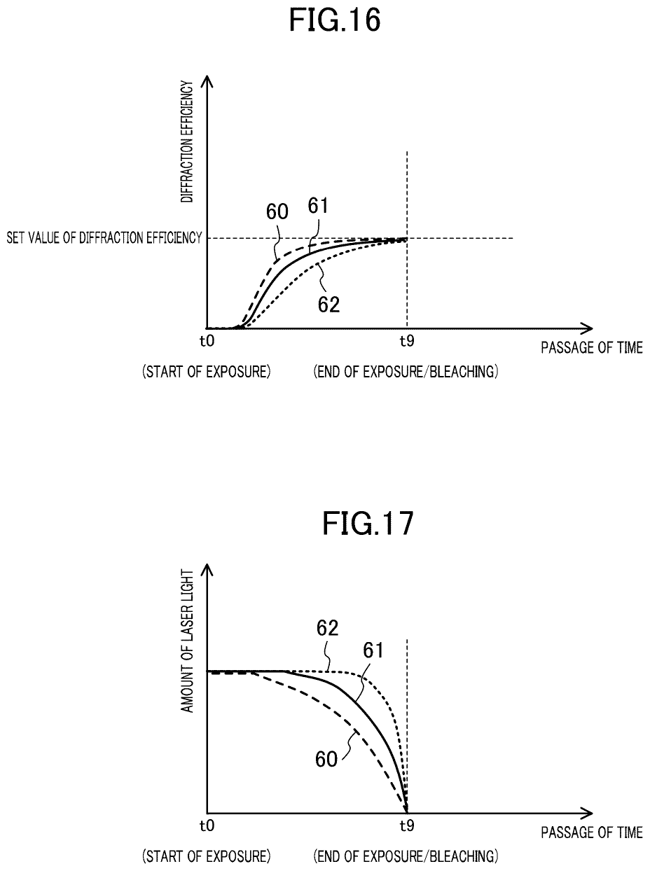

FIG. 16 is a graph showing one example of a change in the diffraction efficiency of the volume hologram according to the fourth embodiment. FIG. 17 is a graph showing one example of a change in the amount of laser light emitted to the volume hologram according to

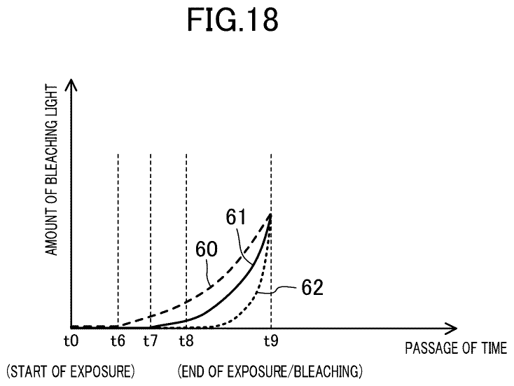

the fourth embodiment. FIG. 18 is a graph showing one example of a change in the amount of bleaching light emitted to the volume hologram according to the fourth embodiment. FIG. 16 shows the diffraction efficiencies of volume holograms 60 to 62 different from each other in material and thickness. FIG. 17 shows the amounts of laser light L1 emitted to the volume holograms 60 to 62 (that is, the total of the amount of laser light L2 and the amount of laser light L3). FIG. 18 shows the amounts of bleaching light L8 emitted to the volume holograms 60 to 62.

As shown in FIGS. 16 to 18, at the time point t0, exposure of the volume holograms 60 to 62 starts. After the start of exposure, the amount of laser light L1 increases to a predetermined value. After a lapse of some time from the time point t0, the diffraction efficiencies of the volume holograms 60 to 62 start increasing. Then, at the time points t6 to t8, bleaching of the volume holograms 60 to 62 starts. Thereafter, the amount of laser light L1 decreases until the time point t9. Then, at the time point t9, exposure and bleaching of the volume holograms 60 to 62 end.

In the present embodiment, the control device 10 calculates the diffraction efficiency of the volume hologram 5 based on the measurement results (actual measurement values of the amounts of laser light L6 and laser light L7) of the power meters 8, 9, and controls the attenuator 15 (amount of laser light L1) and the bleaching light source 13 (amount of bleaching light L8) according to the prediction of the diffraction efficiency of the volume hologram 5 after the stop of exposure. This makes it possible to produce the volume hologram with the set diffraction efficiency even for different materials and thicknesses.

Bleaching is performed on the volume hologram during exposure of the volume hologram. According to the timing of ending bleaching of the volume hologram, exposure of the volume hologram ends. This makes it possible to adjust the timing of stopping exposure of the volume hologram and the timing of ending bleaching to the same timing, and therefore, suppress a change in the diffraction efficiency of the volume hologram after the stop of exposure of the volume hologram and during bleaching.

Note that in each of the above-described embodiments, the first threshold and the third threshold may be the same as or different from each other. Moreover, the second threshold and the fourth threshold may be the same as or different from each other.

The above-described embodiments may be combined with each other. For example, the control device 10 may set the timing of stopping the laser light while controlling at least any one of the amount of laser light or the amount of bleaching light according to the prediction value of the diffraction efficiency.

The exposure apparatus of the present disclosure can be used when the volume hologram is exposed to light (manufactured).

What is claimed is:

1. An exposure apparatus used for exposing a holographic optical element to light, comprising:
a first light source that irradiates the holographic optical element with first light which is light with a predetermined wavelength range in order to detect a first diffraction efficiency which is a diffraction efficiency of the holographic optical element during exposure;
a first detector that detects an amount of the first light; and
a second detector that detects an amount of second light which is the first light diffracted by the holographic optical element.

2. The exposure apparatus of claim 1, further comprising:
an optical element provided on an optical path of the first light from the first light source to the holographic optical element to divide the first light.

3. The exposure apparatus of claim 1, further comprising:
a control device that calculates the first diffraction efficiency based on detection results of the first and second detectors and controls a process of exposing the holographic optical element to the light according to the calculated first diffraction efficiency,
wherein the control device takes, as a value of the first diffraction efficiency, a numerical value obtained by dividing the amount of the second light by the amount of the first light.

4. The exposure apparatus of claim 1, further comprising:
a prediction device that calculates the first diffraction efficiency based on detection results of the first and second detectors, and predicts a second diffraction efficiency which is a diffraction efficiency of the holographic optical element after stop of exposure according to the calculated first diffraction efficiency.

5. The exposure apparatus of claim 4, wherein
the prediction device predicts the second diffraction efficiency according to a value of the first diffraction efficiency and an amount of change therein.

6. The exposure apparatus of claim 4, further comprising:
a second light source that irradiates the holographic optical element with third light to which the holographic optical element is to be exposed; and
a control device that blocks irradiation of the holographic optical element with the third light according to a prediction result of the prediction device.

7. The exposure apparatus of claim 6, further comprising:
a shutter provided on an optical path of the second light from the second light source to the holographic optical element to block the second light,
wherein the control device controls the shutter according to the prediction result of the prediction device.

8. An exposure method used for exposing a holographic optical element to light, comprising:
irradiating the holographic optical element with first light which is light with a predetermined wavelength range in order to detect a first diffraction efficiency which is a diffraction efficiency of the holographic optical element during exposure;
detecting an amount of the first light; and
detecting an amount of second light which is the first light diffracted by the holographic optical element.

9. The exposure method of claim 8, further comprising:
calculating the first diffraction efficiency based on detection results of the amounts of the first light and the second light and predicting a second diffraction efficiency which is a diffraction efficiency of the holographic optical element after stop of exposure according to the calculated first diffraction efficiency.

10. A method for manufacturing a holographic optical element, comprising:
exposing the holographic optical element to light;
irradiating the holographic optical element with first light which is light with a predetermined wavelength range in order to detect a first diffraction efficiency which is a diffraction efficiency of the holographic optical element during exposure;
detecting an amount of the first light; and
detecting an amount of second light which is the first light diffracted by the holographic optical element.

11. The method for manufacturing the holographic optical element of claim 10, further comprising:
calculating the first diffraction efficiency based on detection results of the amounts of the first light and the second light and predicting a second diffraction efficiency which is a diffraction efficiency of the holographic optical element after stop of exposure according to the calculated first diffraction efficiency.
